(19) United States
(12) Patent Application Publication
(10) Pub. No.: US 2009/0228233 A1
(43) Pub. Date: Sep. 10, 2009

(54) RANK-BASED EVALUATION

(76) Inventors: Gary F. Anderson, Danbury, CT (US); Mark S. Ramsey, Kihei, HI (US); David A. Selby, Nr Fareham (GB); Stephen J. Todd, Winchester (GB)

Correspondence Address: HOFFMAN WARNICK LLC, 75 STATE ST, 14TH FLOOR, ALBANY, NY, 12207, US

(21) Appl. No.: 12/043,605

(22) Filed: Mar. 6, 2008

(51) Int. Cl. G06F 15/00

(52) U.S. Cl. 702/127

(57) ABSTRACT

A solution for evaluating a plurality of entities includes assigning an attribute score to each entity for each of a multitude of attributes. For one or more of the attributes, the corresponding attribute score is assigned based on a ranking of each entity with respect to the other entities for the attribute. A composite score is generated for each entity based on the attribute scores for the attributes, which can be further processed to, for example, identify a set of suspicious entities.

### TECHNICAL FIELD

The disclosure relates generally to evaluating entities, and more particularly, to evaluating entities based on their corresponding attribute rankings.

### BACKGROUND ART

Fraud and other exception detection approaches attempt to detect problems by looking at values of particular attributes of particular entities. Typically, many attributes of each entity are tracked, and the approach seeks to identify exceptional behavior based on the tracked attributes. For example, an entity can be a credit card, and various attributes of its use can be tracked. Similarly, the entity can be an employee for which various aspects of his/her behavior are tracked, a health provider for which various aspects of its medical service reimbursement requests are tracked, etc.

In a typical approach, a score is generated for each attribute of each entity based on a corresponding value of the attribute. To date, various approaches use statistical data to define a “normal” range of values for the attribute (e.g., by calculating a mean, mode, and/or standard deviation) and calculate attribute scores based on the value of the attribute and the statistical data. The attribute score is then analyzed with respect to its variance from the normal range of values. Some approaches seek to improve analysis of these calculations by using artificial intelligence approaches, such as fuzzy logic. The individual attribute scores for an entity are then combined to yield an overall composite score for the entity. Entities with the highest composite scores are the most suspicious and may be flagged for follow up analysis. More complicated approaches incorporate mathematical fitting functions, but these approaches can be very expensive to run in terms of the amount of runtime required and/or the required processing resources.

### SUMMARY OF THE INVENTION

The inventors recognize deficiencies in the current approaches to evaluating entities. For example, many of the current approaches make one or more assumptions about the distribution of data (e.g., Gaussian distribution is often assumed). Additionally, current approaches for defining how to calculate the composite score have weaknesses in mathematical principle and/or in practice. As a result, composite scoring is often not used and/or is supplemented with an expensive, and potentially unreliable, manual review of the individual attribute scores. In light of these deficiencies and other deficiencies not expressly described herein, the inventors present an improved solution for evaluating entities.

Aspects of the invention provide a solution for evaluating a plurality of entities, which includes assigning an attribute score to each entity for each of a multitude of attributes. For one or more of the attributes, the corresponding attribute score is assigned based on a ranking of each entity with respect to the other entities for the attribute. A composite score is generated for each entity based on the attribute scores for the attributes, which can be further processed to, for example, identify a set of suspicious entities.

A first aspect of the invention provides a method of evaluating a plurality of entities, the method comprising: assigning an attribute score to each entity for each of a plurality of attributes, the assigning an attribute score including assigning a ranking to each entity with respect to the other entities for at least one of the plurality of attributes; generating a composite score for each entity based on the attribute scores for the plurality of attributes; and writing the composite scores for the entities to a computer-readable medium for further processing.

A second aspect of the invention provides a system for evaluating a plurality of entities, the system comprising: a component for assigning an attribute score to each entity for each of a plurality of attributes, wherein the component for assigning an attribute score assigns a ranking to each entity with respect to the other entities for at least one of the plurality of attributes; and a component for generating a composite score for each entity based on the attribute scores for the plurality of attributes and writing the composite scores for the entities to a computer-readable medium for further processing.

A third aspect of the invention provides a computer program comprising program code embodied in at least one computer-readable medium, which when executed, enables a computer system to implement a method of evaluating a plurality of entities, the method including: assigning an attribute score to each entity for each of a plurality of attributes, the assigning an attribute score including assigning a ranking to each entity with respect to the other entities for at least one of the plurality of attributes; generating a composite score for each entity based on the attribute scores for the plurality of attributes; and writing the composite scores for the entities to a computer-readable medium for further processing.

A fourth aspect of the invention provides a method of generating a system for evaluating a plurality of entities, the method comprising: providing a computer system operable to: assign an attribute score to each entity for each of a plurality of attributes, the assigning an attribute score including assigning a ranking to each entity with respect to the other entities for at least one of the plurality of attributes; generate a composite score for each entity based on the attribute scores for the plurality of attributes; and write the composite scores for the entities to a computer-readable medium for further processing.

A fifth aspect of the invention provides a method comprising: at least one of providing or receiving a copy of a computer program that is embodied in a set of data signals, wherein the computer program enables a computer system to implement a method of evaluating a plurality of entities, the method including: assigning an attribute score to each entity for each of a plurality of attributes, the assigning an attribute score including assigning a ranking to each entity with respect to the other entities for at least one of the plurality of attributes; generating a composite score for each entity based on the attribute scores for the plurality of attributes; and writing the composite scores for the entities to a computer-readable medium for further processing.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative environment for evaluating entities according to an embodiment.

FIG. 2 shows an illustrative process for evaluating entities according to an embodiment.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for evaluating a plurality of entities, which includes assigning an attribute score to each entity for each of a multitude of attributes. For one or more of the attributes, the corresponding attribute score is assigned based on a ranking of each entity with respect to the other entities for the attribute. A composite score is generated for each entity based on the attribute scores for the attributes, which can be further processed to, for example, identify a set of suspicious entities. As used herein, unless otherwise noted, the term “set” means one or more (i.e., at least one) and the phrase “any solution” means any now known or later developed solution.

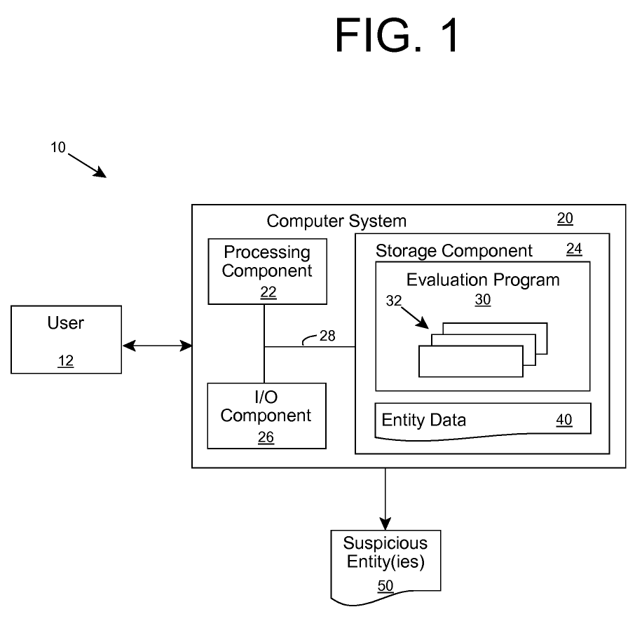

Turning to the drawings, FIG. 1 shows an illustrative environment 10 for evaluating entities according to an embodiment. To this extent, environment 10 includes a computer system 20 that can perform a process described herein in order to evaluate entities, e.g., to identify one or more suspicious entities 50. In particular, computer system 20 is shown including an evaluation program 30, which makes computer system 20 operable to evaluate entities by performing a process described herein.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as evaluation program 30, which is at least partially stored in storage component 24. While executing program code, processing component 22 can process data, which can result in reading and/or writing the data to/from storage component 24 and/or I/O component 26 for further processing. Pathway 28 provides a communications link between each of the components in computer system 20. I/O component 26 can comprise one or more human I/O devices, which enable a human user 12 to interact with computer system 20 and/or one or more communications devices to enable a system user 12 to communicate with computer system 20 using any type of communications link. To this extent, evaluation program 30 can manage a set of interfaces (e.g., graphical user interface(s), application program interface, and/or the like) that enable human and/or system users 12 to interact with evaluation program 30. Further, evaluation program 30 can manage (e.g., store, retrieve, create, manipulate, organize, present, etc.) the data, such as entity data 40, using any solution.

In any event, computer system 20 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, evaluation program 30 can be embodied as any combination of system software and/or application software.

Further, evaluation program 30 can be implemented using a set of modules 32. In this case, a module 32 can enable computer system 20 to perform a set of tasks used by evaluation program 30, and can be separately developed and/or implemented apart from other portions of evaluation program 30. As used herein, the terms component and module mean any configuration of hardware, with or without software, which implements and/or enables a computer system 20 to implement the functionality described in conjunction therewith using any solution. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of evaluation program 30 installed thereon (e.g., one or more modules 32). However, it is understood that computer system 20 and evaluation program 30 are only representative of various possible equivalent computer systems that may perform a process described herein. To this extent, in other embodiments, the functionality provided by computer system 20 and evaluation program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, evaluation program 30 enables computer system 20 to evaluate entities. As used herein, “entity” refers to any physical or conceptual object, person, event, group of related items, and/or the like, about which information is stored. The information can include data on a plurality of attributes of the entity. For example, an illustrative entity can comprise a credit card, and the information can comprise data on a corresponding set of credit card transactions. Similarly, an illustrative entity can comprise a medical practice, and the information can comprise data on a corresponding set of reimbursement claims made by the medical practice. It is understood that these entities are only illustrative, and numerous types of entities are possible under various possible implementations of an embodiment of the invention.

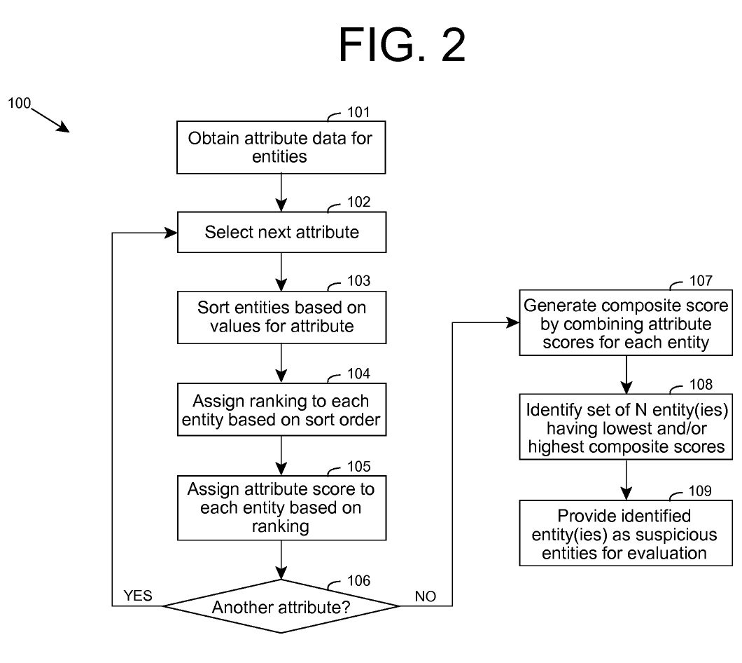

FIG. 2 shows an illustrative process 100 for evaluating entities, which can be implemented by computer system 20 (FIG. 1), according to an embodiment. Referring to FIGS. 1 and 2, in process 101, computer system 20 can obtain entity data 40 for a group of entities using any solution. For example, computer system 20 can generate and/or be used to generate entity data 40, retrieve entity data 40 from one or more data stores, receive entity data 40 from another system, and/or the like. Regardless, entity data 40 includes data on various attributes of entities that are to be evaluated by computer system 20. In an illustrative application, entity data 40 may include data on forty or more different attributes for each of hundreds or thousands of entities. It is understood that entity data 40 may not expressly include attribute data for every attribute of the entity. In this case, computer system 20 can use default data (e.g., a default value) for the attribute, not process the attribute, and/or the like.

In processes 102-106, computer system 20 can sequentially process each attribute in entity data 40 to assign an attribute score for each attribute of each entity. However, it is understood that this is only illustrative of various processes that computer system 20 can implement to assign the attribute scores. To this extent, in other embodiments, computer system 20 can assign the attribute scores in parallel and/or using any alternative process that will result in each entity being evaluated having a rank-based attribute score assigned to each attribute thereof. Additionally, while each attribute is shown and described as having a rank-based attribute score, it is understood that computer system 20 can calculate the attribute scores for one or more attributes using any solution, such as a non-rank-based solution.

In any event, in process 102, computer system 20 can select a next attribute for processing. In process 103, computer system 20 can sort all of the entities being evaluated based on a corresponding value each entity has for the attribute. Computer system 20 can implement any algorithm and utilize any set of criteria in sorting the entities based on their corresponding values for the attribute. For example, when the values are a single numeric value, computer system 20 can sort the entities from highest to lowest, lowest to highest, and/or the like. Further, computer system 20 can implement any solution for handling a sort-based tie (e.g., same value for an attribute) between two or more entities. In an embodiment, computer system 20 can assign multiple entities to the same location in the sort order. Further, computer system 20 can utilize a secondary set of comparison criteria (e.g., value(s) for one or more related attributes) to determine a final sort order for the entities.

In process 104, computer system 20 can assign a ranking to each entity based on its corresponding location in the sort entities using any solution. In particular, computer system 20 can assign a ranking of one for the first entity, a ranking of two for the second entity, etc. When two or more entities are in the same location in the sort order, computer system 20 can assign the same ranking to the entities in a known manner (e.g., two entities ranked third with the next entity ranked fifth).

In process 105, computer system 20 can assign an attribute score to each entity based on the ranking. Computer system 20 can implement any of various solutions for assigning an attribute score based on a ranking. For example, in an embodiment, computer system 20 can use the ranking as the attribute score. Alternatively, computer system 20 can convert the ranking into a probability to yield the attribute score (e.g., attribute score=ranking/number of entities). The use of a rank-based attribute score automatically adjusts to the particular data distribution, and therefore gives a reasonable probability/improbability as to the score. In particular, regardless of the particular value for a given attribute, for a sufficiently large number of entities being evaluated, it may be highly unlikely to have the smallest and/or largest value for the attribute. As a result, a low and/or high ranking for a given attribute will make the entity suspicious for the attribute.

Computer system 20 can implement various alternative solutions for assigning the attribute score. To this extent, computer system 20 can calculate the attribute scores using a logarithmic scale. For example, for an attribute, a, an entity, e, a ranking for the entity with respect to the attribute, R(e, a), and a total number of entities, E, computer system 20 can calculate each attribute score, FS(e, a), using the formula:

FS(e, a)=−log(R(e, a)/E).

In this case, larger scores will be assigned for more extreme (e.g., less probable) entities. Further, the attribute scores can provide more “user-friendly” values than the probabilities discussed above when, for example, a human user 12 will be reviewing the attribute scores. In any event, computer system 20 can select/use any base of the logarithm, which can be selected/altered for convenience (e.g., based on a range of values, a desired range of attribute scores, etc.). Similarly, computer system 20 can adjust the attribute scores to fit within a predetermined range. For example, computer system 20 can scale the attribute scores to a range between 0 and 1000, which is a range commonly used in evaluating entities.

While deriving an attribute score based exclusively on rank rather than the actual values as described herein adapts to the particular data distribution, the adaptation may be too extreme for some applications. For example, the attribute score may adjust too much for random clustering of values, and not enough for extreme values. To this extent, in process 104, computer system 20 can implement any solution for smoothing the rankings. Computer system 20 can then use the smoothed rankings to assign an attribute score in process 105.

In an embodiment, computer system 20 can smooth the assigned rankings for an attribute based on the corresponding value for each entity. In this case, after assigning the rankings, computer system 20 can compute the smoothed rankings based on the values, and consider the rankings as a (monotone increasing) mapping, RV, from rank, R, to value, V. For example, for an entity, e, and attribute, a, a rank, R(e, a), can be mapped to a value, V(e, a), using the mapping RV(R)=V(e, a). Computer system 20 can calculate a smoothed mapping, RV′(R), using any smoothing formula, such as:

RV′(R)=(RV(R−1)+2*RV(R)+RV(R+1))/4.

Computer system 20 can find the position of R′(e, a) in the smoothed RV′ mapping for each entity using any solution. For example, computer system 20 can use binary chop to find the next lowest entry, RL′, such that:

RV(RL′)<=V(e, a), but RV(RL′+1)>V(e, a),

and use interpolation (e.g., linear) to compute R′, e.g., using the formula:

R′=RL+(V(e, a)−RV(RL′))/(RV(RL′+1)−RV(RL′)).

In any event, in decision 106, computer system 20 can determine whether attribute scores need to be assigned for another attribute of the entities. If so, flow can return to process 102. If not, in process 107, computer system 20 can generate a composite score for each entity based on its corresponding attribute scores for the plurality of attributes. For example, computer system 20 can combine the attribute scores using any solution, to yield the composite score. In an embodiment, computer system 20 can multiply the attribute scores for each of the plurality of attributes (e.g., when the attribute scores are based on probabilities). Similarly, computer system 20 can add the attribute scores for each of the plurality of attributes (e.g., when the attribute scores are logarithmic). Still further, computer system 20 can compute an average of the attribute scores (e.g., when they have all been scaled). Still further, once the attribute scores have been combined, computer system 20 can perform further processing, such as scaling the values to a predetermined range, to generate the composite score using any solution.

It is understood that computer system 20 can implement any appropriate solution for generating the composite scores, which can be selected based on the nature of entity data 40, the method(s) used to calculate the attribute scores, an application for the composite scores, and/or the like. For example, computer system 20 can apply a weight to one or more attribute scores, which may be more or less important than other attribute scores in an overall analysis of the entity data 40. Further, when two or more attributes are known to have a dependency relationship, computer system 20 can merge the attribute scores for the two or more attributes into a single attribute score, which is used to generate the composite score, using any solution. For example, computer system 20 can use a minimum attribute score, a maximum attribute score, an average attribute score, a statistical calculation (e.g., Bayesian), and/or the like, as the merged attribute score for two or more interdependent attributes. If desired, computer system 20 can apply a weight to the merged score when generating the composite score using any solution.

Computer system 20 can store the composite scores for each entity for further processing and/or analysis by, for example, user 12. Alternatively, computer system 20 can perform further processing/analysis of the composite scores to yield a preliminary or final evaluation of the entities. For example, in process 108, computer system 20 can identify a set of entities having the lowest and/or highest composite scores. Computer system 20 and/or a user 12 can select the number, N, of entities in the set using any solution, such as a fixed number of entities, a fixed percentage of entities, a number of entities having a composite score below and/or above threshold value(s), and/or the like.

In an illustrative application, computer system 20 can identify a set of suspicious entities based on the composite scores, which can be further analyzed by user 12 to determine whether any problems/improper behaviors are present for the entities. In this case, in process 109, computer system 20 can provide the identified set of entities having the lowest and/or highest composite scores for evaluation by user 12 using any solution (e.g., by communicating, displaying, and/or the like).

While shown and described herein as a method and system for evaluating entities, it is understood that aspects of the invention further provide various alternative embodiments. For example, in one embodiment, the invention provides a computer program embodied in at least one computer-readable medium, which when executed, enables a computer system to evaluate entities. To this extent, the computer-readable medium includes program code, such as evaluation program 30 (FIG. 1), which implements some or all of a process described herein. It is understood that the term “computer-readable medium” comprises one or more of any type of tangible medium of expression capable of embodying a copy of data, such as the program code (e.g., a physical embodiment). For example, the computer-readable medium can comprise: one or more portable storage articles of manufacture; one or more memory/storage components of a computing device; a modulated data signal having one or more of its characteristics set and/or changed in such a manner as to encode information in the signal; paper; and/or the like.

In another embodiment, the invention provides a method of providing a copy of program code, such as evaluation program 30 (FIG. 1), which implements some or all of a process described herein. In this case, a computer system can generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program embodied in at least one computer-readable medium. In either case, the set of data signals can be transmitted/received using any type of communications link.

In still another embodiment, the invention provides a method of generating a system for evaluating entities. In this case, a computer system, such as computer system 20 (FIG. 1), can be obtained (e.g., created, maintained, made available, etc.) and one or more modules for performing a process described herein can be obtained (e.g., created, purchased, used, modified, etc.) and deployed to the computer system. To this extent, the deployment can comprise one or more of: (1) installing program code on a computing device from a computer-readable medium; (2) adding one or more computing and/or I/O devices to the computer system; and (3) incorporating and/or modifying the computer system to enable it to perform a process described herein.

It is understood that aspects of the invention can be implemented as part of a business method that performs a process described herein on a subscription, advertising, and/or fee basis. That is, a service provider could offer to evaluate entities as described herein. In this case, the service provider can manage (e.g., create, maintain, support, etc.) a computer system, such as computer system 20 (FIG. 1), that performs a process described herein for one or more customers. In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of evaluating a plurality of entities, the method comprising:
assigning an attribute score to each entity for each of a plurality of attributes, the assigning an attribute score including assigning a ranking to each entity with respect to the other entities for at least one of the plurality of attributes;
generating a composite score for each entity based on the attribute scores for the plurality of attributes; and
writing the composite scores for the entities to a computer-readable medium for further processing.

2. The method of claim 1, the assigning a ranking including:
sorting the entities based on a corresponding value each entity has for the at least one of the plurality of attributes; and
assigning the ranking to each entity based on a location of the entity in the sorted entities.

3. The method of claim 2, the assigning a ranking further including smoothing the assigned rankings based on the corresponding values for each entity.

4. The method of claim 1, the assigning an attribute score further including converting the ranking for each entity for the at least one of the plurality of attributes to a probability.

5. The method of claim 1, the assigning an attribute score further including adjusting the attribute scores for the at least one attribute to fit within a predetermined range.

6. The method of claim 1, the generating including merging the attribute scores of at least two attributes into a single attribute score based on a dependency relationship between the at least two attributes.

7. The method of claim 1, further comprising identifying a set of suspicious entities based on the composite scores.

8. The method of claim 7, the identifying including selecting a subset of the plurality of entities having at least one of: the lowest composite scores or the highest composite scores for the plurality of entities.

9. A system for evaluating a plurality of entities, the system comprising:
a component for assigning an attribute score to each entity for each of a plurality of attributes, wherein the component for assigning an attribute score assigns a ranking to each entity with respect to the other entities for at least one of the plurality of attributes; and
a component for generating a composite score for each entity based on the attribute scores for the plurality of attributes and writing the composite scores for the entities to a computer-readable medium for further processing.

10. The system of claim 9, wherein the component for assigning smooths the assigned rankings based on a corresponding value each entity has for the at least one of the plurality of attributes.

11. The system of claim 9, wherein the component for assigning converts the ranking for each entity for the at least one of the plurality of attributes to a probability.

12. The system of claim 9, wherein the component for assigning adjusts the attribute scores for the at least one attribute to fit within a predetermined range.

13. The system of claim 9, wherein the component for generating merges the attribute scores of at least two attributes into a single attribute score based on a dependency relationship between the at least two attributes.

14. The system of claim 9, further comprising a component for identifying a set of suspicious entities based on the composite scores.

15. A computer program comprising program code embodied in at least one computer-readable medium, which when executed, enables a computer system to implement a method of evaluating a plurality of entities, the method including:
assigning an attribute score to each entity for each of a plurality of attributes, the assigning an attribute score including assigning a ranking to each entity with respect to the other entities for at least one of the plurality of attributes;
generating a composite score for each entity based on the attribute scores for the plurality of attributes; and
writing the composite scores for the entities to a computer-readable medium for further processing.

16. The computer program of claim 15, the assigning a ranking further including smoothing the assigned rankings based on a corresponding value each entity has for the at least one of the plurality of attributes.

17. The computer program of claim 15, the assigning an attribute score further including adjusting the attribute scores for the at least one attribute to fit within a predetermined range.

18. The computer program of claim 15, the generating including merging the attribute scores of at least two attributes into a single attribute score based on a dependency relationship between the at least two attributes.

19. The computer program of claim 15, the method further including identifying a set of suspicious entities based on the composite scores.

20. A method of generating a system for evaluating a plurality of entities, the method comprising:
providing a computer system operable to:
assign an attribute score to each entity for each of a plurality of attributes, the assigning an attribute score including assigning a ranking to each entity with respect to the other entities for at least one of the plurality of attributes;
generate a composite score for each entity based on the attribute scores for the plurality of attributes; and
write the composite scores for the entities to a computer-readable medium for further processing.
